(19) United States
(12) Patent Application Publication
(10) Pub. No.: US 2026/0245454 A1
(43) Pub. Date: Aug. 20, 2026

(54) FLOOR SIGNAL SYSTEM FOR PREVENTING DILEMMA ZONES

(71) Applicant: Industry-University Cooperation Foundation Sunmoon University, Asan-si (KR)

(72) Inventors: Minsoo KANG, Asan-si (KR); Jonghwan YUN, Pyeongtaek-si (KR); Hongbeom RA, Hwaseong-si (KR); Donggyu JANG, Cheonan-si (KR)

(73) Assignee: Industry-University Cooperation Foundation Sunmoon University, Asan-si (KR)

(21) Appl. No.: 19/057,107

(22) Filed: Feb. 19, 2025

(30) Foreign Application Priority Data
Feb. 17, 2025 (KR) 10-2025-0020290

(51) Int. Cl. G08G 1/095; G08G 1/01; G08G 1/052; G08G 1/056; H05B 45/10

(52) U.S. Cl. CPC G08G 1/095; G08G 1/0116; G08G 1/0133; G08G 1/0141; G08G 1/0145; G08G 1/052; G08G 1/056; H05B 45/10

(57) ABSTRACT

Provided is a floor signal system for preventing a dilemma zone that includes: a detection device that detects a speed, a location, and a direction of a vehicle approaching an intersection and generates detection data; an operating device installed in a road section connected to the intersection and emitting a visual signal related to whether to allow a vehicle to enter the intersection; and a control server that detects a signal status of the intersection and determines whether a yellow signal shift occurs, and based on a timing of the yellow signal shift, controls a lighting section and a lighting pattern of the operating device based on the detection data received from the detection device.

### CROSS-REFERENCE TO RELATED APPLICATION

This application claims priority to and the benefit of Korean Patent Application No. 10-2025-0020290, filed on Feb. 17, 2025, the disclosure of which is incorporated herein by reference in its entirety.

### BACKGROUND

### 1. Field of the Invention

The present invention relates to a signal control system for improving driving safety of a vehicle at an intersection, and more specifically, to a system for providing a floor auxiliary light emitting diode (LED) signal to prevent a driver's dilemma zone based on speed and location data of a vehicle.

### 2. Discussion of Related Art

The present invention relates to a signal control system for improving the driving safety of vehicles at an intersection. An intersection is a point at which vehicles cross and move in various directions, and is generally provided with a traffic light system that controls vehicle movement through green, yellow, and red signals. However, the existing traffic light system does not reflect detailed conditions such as the speeds, locations, and intersection entry situations of vehicles, which frequently causes dilemma zones in which it is difficult for a driver to determine whether to pass through the intersection or stop when encountering a yellow signal to appear.

A dilemma zone is a section in which a vehicle approaches an intersection and it is difficult to determine whether to decelerate and stop according to a stop signal or accelerate to safely pass through the intersection. Incorrect decision of the driver in this section may lead to serious issues.

First, there is an increased risk of collisions between a vehicle attempting to pass through the intersection at a yellow signal and a vehicle attempting to stop at the yellow signal, which increases the possibility of a large-scale accident.

Second, sudden acceleration or deceleration makes it difficult to maintain the distance between vehicles, which increases the possibility of causing a rear-end collision with a following vehicle.

Third, the time taken by drivers to make decisions results in unnecessary stops and congestion, which degrades the traffic flow throughout the intersection.

In the conventional technology, several attempts have been made to resolve the dilemma zone issues. Representative methods include adjusting the timing of signal change or optimizing signal control through vehicle detection sensors. For example, the methods may operate such that the timing of traffic lights is associated with vehicle speeds, or the signal change time is adjusted by detecting the approach of a vehicle with a detection sensor installed adjacent to a stop line. However, these methods have limitations of failing to reflect speed and location data of individual vehicles in real time or failing to provide drivers with clear signal transmission.

In particular, the existing intersection signal control systems have failed to provide drivers with intuitive and clear criteria for making driving decisions, which results in an increased burden on drivers'decisions and has limitations in reducing the possibility of accidents. In addition, there are continuing issues of worsening traffic congestion due to uneven driving decisions between vehicles.

Accordingly, there is an increasing need for research and development on a system that analyzes the speeds and locations of vehicles approaching an intersection in real time and provides intuitive and clear visual signals such that drivers may rapidly and accurately determine whether to drive.

### SUMMARY OF THE INVENTION

The present invention is directed to effectively reducing the confusion in decision that occurs in a dilemma zone and the resulting risk of accidents by analyzing the speed and location of a vehicle in real time when the vehicle is approaching an intersection and providing a clear visual signal such that the driver may intuitively determine whether to drive.

The technical objectives of the present invention are not limited to the above, and other objectives that are not described above will be clearly understood by those skilled in the art from the above detailed description.

According to an aspect of the present invention, there is provided a floor signal system for preventing a dilemma zone. The system includes: a detection device that detects a speed, a location, and a direction of a vehicle approaching an intersection and generates detection data; an operating device installed in a road section connected to the intersection and emitting a visual signal related to whether to allow a vehicle to enter the intersection; and a control server that detects a signal status of the intersection and determines whether a yellow signal shift occurs, and based on a timing of the yellow signal shift, controls a lighting section and a lighting pattern of the operating device based on the detection data received from the detection device.

The detection device may be installed on a road section farther from the intersection than the operating device, and may be provided with a plurality of sensor modules, and the operating device may include a plurality of light emitting diode (LED) modules arranged at a certain interval on the road section connected to the intersection, and each of the plurality of LED modules may be provided with a blind that adjusts a light emission angle of the visual signal such that a driver of the vehicle may identify the visual signal only at a specific angle.

Each of the plurality of LED modules may be formed so that an angle of the blind gradually changes with an increasing distance from the intersection to increase the light emission angle such that the visual signal may be identified at a wider angle as the distance from the intersection increases.

The control server may generate a control signal for variably adjusting the light emission angle of the blind based on traffic congestion, time zone, or vehicle flow data, and each of the plurality of LED modules may adjust the light emission angle of the blind in real time according to the control signal received from the control server.

The operating device may include a light sensor module that obtains light detection data related to ambient lighting conditions, and the plurality of LED modules may adjust a lighting intensity based on the light detection data obtained from the light sensor module.

The control server may analyze in real time the timing of the yellow signal shift and the data regarding the speed and location of the vehicle received from the detection device to calculate whether to allow each of a plurality of vehicles to enter the intersection, generate in real time a lighting control signal for controlling the lighting of each of the plurality of LED modules according to a change in a location of each vehicle, and dynamically adjust an intersection entry-allowable section and a stop section to provide an individual visual signal according to a direction in which the vehicle is headed.

The floor signal system may further include an additional detection device that obtains complexity data within the intersection, wherein the additional detection device may generate the complexity data based on data on a speed and number of vehicles in the intersection, and the control server may determine whether to allow a vehicle to enter the intersection by reflecting the complexity data with priority over the detection data received from the detection device, and control the operating device based on a result of the determination.

The detection device may further include an emergency vehicle detection module that detects an approach of an emergency vehicle to the intersection and generates emergency vehicle approach data, and the control server, based on the emergency vehicle approach data received from the emergency vehicle detection module, may turn on LED modules corresponding to an expected passage route of the emergency vehicle among the plurality of LED modules to indicate a priority passage route of the emergency vehicle, and provide a stop signal to other general vehicles that have a possibility of colliding with the emergency vehicle within the intersection section.

Other specific details according to the present invention are included in the specification and the accompanying drawings.

### BRIEF DESCRIPTION OF THE DRAWINGS

Various aspects are now described with reference to the drawings, wherein like reference numerals are collectively used to indicate like elements. In the following examples, for purposes of explanation, numerous specific details are presented to provide a thorough understanding of one or more aspects. It will be apparent, however, that such aspects may be practiced without these specific details.

FIG. 1 is an exemplary diagram for describing a floor signal system for preventing a dilemma zone according to an embodiment of the present invention.

FIG. 2 is an exemplary block diagram of a floor signal system for preventing a dilemma zone according to an embodiment of the present invention.

FIGS. 3 to 5 are exemplary diagrams for describing operation processes of a detection device and an operating device in various situations.

### DETAILED DESCRIPTION OF EXEMPLARY EMBODIMENTS

Various embodiments and/or aspects will now be described with reference to the drawings. In the following description, for purposes of explanation, numerous specific details are set forth to provide a thorough understanding of one or more aspects. However, it will also be appreciated by one of ordinary skill in the art that such aspect(s) may be practiced without these specific details. The following description and accompanying drawings set forth in detail certain illustrative aspects of one or more aspects. These aspects are illustrative, however, some of the various methods in principles of various aspects may be employed, and the descriptions set forth are intended to include all such aspects and their equivalents. Specifically, as used herein, “embodiment,” “example,” “aspect,” “exemplary,” etc., are not to be construed as an advantage of any aspect or design over other aspects or designs.

Hereinafter, the same or similar components are assigned the same reference numerals throughout the drawings, and redundant description thereof will be omitted. In addition, in describing the embodiments disclosed in the present specification, if it is determined that detailed description of related known technologies may obscure the gist of the embodiments disclosed in the present specification, such detailed description will be omitted. In addition, the accompanying drawings are only for easy understanding of the embodiments disclosed in the present specification, and the technical ideas disclosed in the present specification are not limited by the accompanying drawings.

Although “first,” “second,” etc., are used to describe various elements, these elements are not limited by these terms, of course. These terms are only used to distinguish one element or component from another. Therefore, it goes without saying that a first element or component mentioned below may be a second element or component within the spirit of the present invention.

Unless otherwise defined, all terms (including technical and scientific terms) used herein may be used with meanings commonly understood by those of ordinary skill in the art to which the present invention belongs. In addition, terms defined in a commonly used dictionary are not to be interpreted ideally or excessively unless clearly specifically defined.

In addition, the term “or” is intended to mean an inclusive “or” rather than an exclusive “or.” That is, unless otherwise specified or clear from context, “X employs A or B” is intended to mean one of the natural implicit substitutions. That is, “X employs A or B” may apply to any of the cases in which X employs A, X employs B, or X employs both A and B. It should also be understood that the term “and/or” as used herein refers to and includes all possible combinations of one or more of the listed related items.

Also, the terms “comprise” and/or “comprising” mean that the feature and/or element is present, but do not exclude the presence or addition of one or more other features, elements and/or groups thereof. Also, unless otherwise specified or unless it is clear from context to refer to a singular referent, a singular form in the specification and claims should generally be construed to mean “one or more.”

When a component is referred to as being “connected” or “attached” to another component, it is understood that it may be directly connected or attached to the other component, or other components may exist between them. On the other hand, when it is said that a certain element is “directly connected” or “directly attached” to another element, it should be understood that there is no other element between them.

The labels “module” and “part” for components used in the following description are given or mixed in consideration of only the ease of writing the specification, and do not have a meaning or role distinct from each other by themselves.

References to an element or layer “on” or “above” another element or layer mean that the other element or layer is directly above the element or layer or that there is an intervening element or layer. On the other hand, when a component is referred to as “directly on” or “immediately on” another, it indicates that no other component or layer is interposed therebetween.

Spatially relative terms “below,” “beneath,” “lower,” “above,” “upper,” etc., can be used to easily describe a component or a correlation with other components. The spatially relative terms should be understood to include different orientations of the device during use or operation in addition to the orientation shown in the drawings.

For example, when a component shown in the drawing is turned over, a component described as “below” or “beneath” another component may then be placed “above” the other component. Accordingly, the exemplary term “below” may include both upward and downward directions. Components may also be oriented in other orientations, and thus spatially relative terms may be interpreted according to orientation.

Objects and effects of the present disclosure, and technical configurations for achieving them will become clear with reference to the embodiments described below in detail in conjunction with the accompanying drawings. In describing the present disclosure, if it is determined that detailed description of a well-known function or configuration may unnecessarily obscure the subject matter of the present disclosure, such detailed description will be omitted. The terms used below are defined in consideration of functions in the present disclosure, which may vary according to the intention or custom of the user or operator.

However, the present disclosure is not limited to the embodiments disclosed below and may be implemented in various different forms. The present embodiments are provided only so that the present disclosure is complete, and to fully inform those of ordinary skill in the art to which the present disclosure belongs of the scope of the disclosure, and the present disclosure is defined only by the scope of the claims. Therefore, definitions should be made based on the content throughout this specification.

The present invention relates to a floor signal system for preventing accidents occurring in a dilemma zone by supporting drivers in intuitively determining whether to drive when a yellow signal is emitted at an intersection.

In general, an intersection is a point at which vehicles cross and move in various directions, and the flow of vehicles is controlled by traffic lights. However, a yellow signal in a signal system at an intersection is a point in time requiring a driver's decision and causes a dilemma situation in which vehicles close to a stop line need to stop, and vehicles far from the intersection need to safely pass through the intersection. Such a section is often referred to as a dilemma zone, and it carries a high risk of causing an accident when a driver fails to make an appropriate choice.

For example, when a vehicle traveling at a high speed encounters a yellow signal, the driver needs to rapidly determine whether to stop or pass through the intersection. In this case, when the vehicle is moving at a high speed or is at an ambiguous distance from the intersection, slamming on the brake to stop may result in an accident with a following vehicle. Conversely, attempting to pass through the intersection without stopping may increase the risk of colliding with other vehicles already in the intersection. Such situations are especially frequent at intersections near highway exits, intersections with fast traffic flow in urban areas, and intersections with long signal waiting times at traffic lights.

Furthermore, in situations in which a plurality of vehicles are moving in close proximity, a leading vehicle and a following vehicle are more likely to make conflicting decisions. For example, when the leading vehicle suddenly stops in response to a stop signal, the following vehicle may choose to accelerate without expecting the stop, which may lead to a major rear-end collision. In traffic flow that includes large vehicles, the scale of the accident is likely to be even greater due to the difference in braking distances caused by rapid acceleration and deceleration.

Dilemma zones are not simply an issue for individual vehicles but also have a negative impact on overall traffic flow. Inconsistent decisions between vehicles at a yellow light increases congestion in an intersection, and unnecessary stops and starts reduce the efficiency of the intersection. These issues are further aggravated at night, in bad weather, or in situations in which drivers have difficulty securing visibility, increasing driver stress and the risk of traffic accidents.

The risk associated with such dilemma zones arises from the existing signal systems that do not provide clear criteria to support drivers in making appropriate decisions. The present invention aims to effectively reduce the risk of accidents occurring in dilemma zones and secure the stability of traffic flow within intersections by analyzing the speeds and locations of vehicles and the signal status in real time and providing visual signals that allow drivers to intuitively make decisions.

According to an embodiment of the present invention, a floor signal system (hereinafter, “a signal system”) for preventing a dilemma zone may be installed in an intersection section and a road section connected to the intersection section.

Specifically, a signal system 1000 may include a detection device 100 that detects data regarding a speed, a location, and a direction of a vehicle approaching an intersection in real time, an operating device 200 installed on a road floor to intuitively convey whether the vehicle is able to drive, and a control server 300 that analyzes data between the detection device 100 and the operating device 200 and performs control.

In the embodiment, the detection device 100 may be installed on a road section at a certain distance from the intersection and may include a plurality of sensor modules. Each sensor module may detect the approach of a vehicle, collect data regarding a speed, a location, and a direction in real time, and transmit the data to the control server 300. For example, when a vehicle approaching the intersection is traveling at a high speed, the detection device 100 may calculate the speed of the vehicle and the distance to the intersection to determine the possibility of entering the dilemma zone. The detection device 100 may be installed to cover various road directions and lanes and may simultaneously process data regarding a plurality of vehicles.

In addition, the operating device 200 may include a plurality of LED modules arranged at a certain interval on the road floor. The LED modules may be configured to provide a visual signal indicating whether the vehicle is able to drive and allow each vehicle to clearly recognize a signal corresponding thereto. In particular, each LED module may be provided with a blind and adjust a signal emission angle through the blind to prevent a following vehicle from misrecognizing the signal of a preceding vehicle. For example, a vehicle that is very close to the LED module is likely to have already seen a signal corresponding thereto and made a decision, and the light emission angle may be adjusted to prevent the signal from being visible to the vehicle. This allows necessary signals to be provided only to specific vehicles and prevents other vehicles from being confused by unnecessary signals. Such a method maximizes the effectiveness of the LED signal and minimizes the risk of misrecognition and accidents that may occur in the dilemma zone by providing drivers with clear decision-making for driving.

In an embodiment, the LED module of the operating device 200 may have a lighting pattern of the signals dynamically controlled according to the change in the location of the vehicle. For example, when the speed of a vehicle attempting to enter the intersection after the yellow signal is emitted is low and the vehicle may not safely pass through the intersection, the control server 300 controls the LED module to provide a stop signal to the vehicle. Conversely, in the case of a vehicle approaching at a high speed, the LED module may emit a pass-through signal to support the vehicle in safely exiting the intersection.

In an embodiment, the control server 300 is a core component of the signal system 1000 and serves to analyze data collected from the detection device 100 in real time and control the LED module of the operating device 200. The control server 300 may calculate whether each of a plurality of vehicles is able to enter the intersection based on an intersection signal status, and data regarding a speed and a location of a vehicle. For example, a vehicle close to an intersection when a yellow signal shift has occurred may be provided with a pass-through signal, and a vehicle far away from the intersection may be provided with a stop signal, thereby preventing a collision accident at the intersection.

In an embodiment, the control server 300 may include a high-performance processor to process the speed, location, and direction data of the vehicle in real time. The processor serves to rapidly analyze data collected from the plurality of sensor modules and calculates an LED module lighting signal suitable for each vehicle. In addition, the processor may comprehensively consider data regarding a moving trajectory of a vehicle, an intersection signal status, and a timing of yellow signal shift to perform dynamic signal control.

In an embodiment, a memory of the control server 300 stores information, such as vehicle data, traffic flow information, and signal status, and is utilized as a workspace required for data analysis and lighting pattern calculation. For example, the control server 300 may process real-time data of the vehicle, while simultaneously storing and utilizing past data and predicted data to implement better signal control. The memory may include both a non-volatile memory and a volatile memory and may be provided to be suitable for real-time processing.

In addition, the control server 300 may communicate with the detection device 100 and the operating device 200 by including a network interface. In order to receive data collected from the detection device 100 and transmit a lighting control signal to the operating device 200, the control server 300 may utilize a wired or wireless communication protocol. For example, the control server 300 may collect data from a sensor module installed on a road section in which a vehicle is located and control an LED module on a road floor based on the analysis results.

The control server 300 may be provided in a centralized manner or may be provided as computing devices distributed at each intersection. A centralized server may manage data from a plurality of intersections in an integrated manner and enable comprehensive control over the entire traffic flow. On the other hand, a distributed server may provide signal control specialized for each intersection and may increase the scalability and stability of the system.

In addition, the control server 300 may be implemented in a network cloud environment, utilizing high-performance cloud computing resources for processing and analyzing real-time data. This may expand the processing capacity of the server or facilitate data integration between various intersections.

As described above, the control server 300 plays an important role in collecting and analyzing data and performing appropriate signal control in the signal system and may contribute to improving the overall performance and safety of the floor signal system for preventing dilemma zones.

According to an embodiment, the control server 300 may receive information such as the signal status of the intersection and the timing of the yellow signal shift from a traffic server. The traffic server is a server that centrally manages a plurality of intersections in a city and may comprehensively control the signal cycles and statuses of each intersection, and the control server 300 may determine a signal pattern suitable for a plurality of vehicles based on the information. For example, when the traffic server transmits the timing of a yellow signal shift of a specific intersection to the control server 300, the control server 300 may determine whether vehicles approaching the intersection are able to drive based on the timing of the yellow signal shift and immediately adjust the lighting pattern of the LED modules.

In an additional embodiment, the traffic server and the control server 300 may exchange information about an emergency vehicle. The traffic server may identify the route of the emergency vehicle and transmit expected intersection entry time and route data of the emergency vehicle to the control server 300. Based on the expected intersection entry time and route data of the emergency vehicle, the control server 300 may display a priority passage route suitable for the emergency vehicle with the LED module and provide a stop signal to other vehicles to support the emergency vehicle in passing safely.

In addition, the control server 300 may also receive signal status information of a neighboring intersection that affects the traffic flow between intersections from the traffic server. For example, when the signal status of a neighboring intersection causes traffic congestion, the control server 300 may control the LED module to delay the progress of the vehicle or extend the stop signal, thereby reducing collisions and congestion between the intersections.

Therefore, the control server 300 may perform more precise signal control through linkage with the traffic server and maximize the safety and efficiency of the traffic flow within the intersection. This may enable integrated use of real-time traffic data and allow effective operation in conjunction with the city-wide traffic system.

As described above, the floor signal system for preventing a dilemma zone according to the present invention may effectively reduce confusion and accident risk occurring in a dilemma zone by analyzing speeds, locations, and direction data of vehicles in real time within an intersection and providing a visual signal that allows a driver to make an intuitive decision.

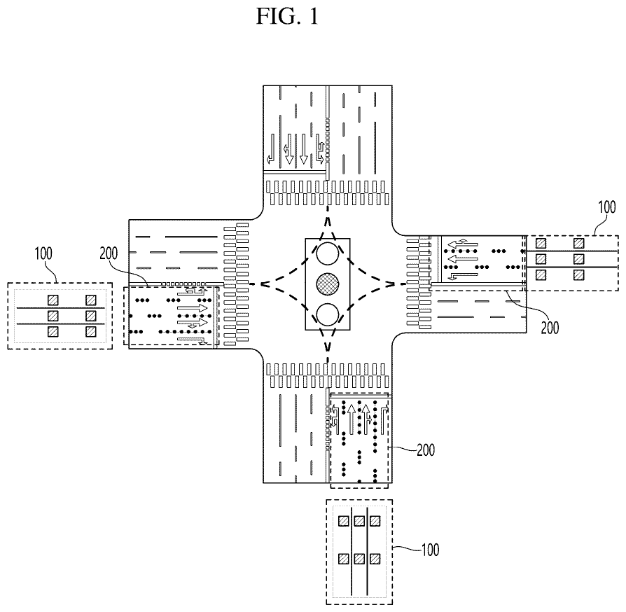

The components included in the floor signal system for preventing a dilemma zone according to the present invention, the operating principle thereof, and the effect through signal control will be described in detail below with reference to FIGS. 1 to 5.

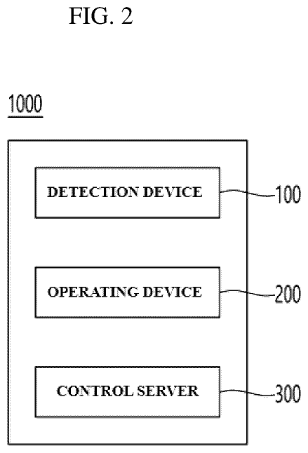

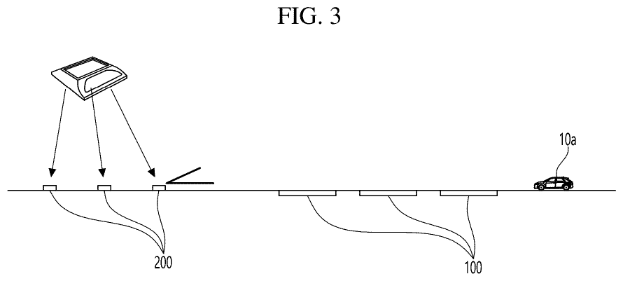

FIG. 1 is an exemplary diagram for describing a floor signal system for preventing a dilemma zone according to an embodiment of the present invention. FIG. 2 is an exemplary block diagram of a floor signal system for preventing a dilemma zone according to an embodiment of the present invention. FIGS. 3 to 5 are exemplary diagrams for describing operation processes of a detection device and an operating device 200 in various situations.

A signal system 1000 according to the present invention is installed in an intersection section and a road section connected to the intersection section and supports intuitive decision of whether a vehicle is able to drive when approaching the intersection.

Referring to FIGS. 1 and 2, the signal system 1000 according to the present invention may include a detection device 100, an operating device 200, and a control server 300.

In an embodiment, the detection device 100 is installed in a road section a certain distance away from an intersection and includes a plurality of sensor modules to detect data regarding a speed, a location, and a direction of a vehicle in real time. In an embodiment, the detection device 100 may be installed by being buried in the floor of a road and may be provided to precisely collect approach and movement data of a vehicle.

More specifically, the detection device 100 may collect data regarding a speed, a location, and a direction of a vehicle when the vehicle approaching the intersection passes the installed sensor, and generate detection data. The detection data may include information about the speed of the vehicle, the distance between the vehicle and the intersection, the direction of movement of the vehicle, and information of a lane occupied by the vehicle. For example, when the detection device 100 is implemented as a plurality of pressure sensors embedded in the road floor, the detection device 100 may measure the load of the vehicle at the moment the vehicle passes the sensor and calculate the exact location and direction of movement of the vehicle in real time.

The detection device 100 transmits the detection data to the control server 300 such that the detection data can be used for analysis. For example, the detection device 100 may detect the speed and location of a vehicle rapidly approaching an intersection and transmit the speed and location of the vehicle to the control server 300 to contribute to determining whether the vehicle is able to enter the intersection. In addition, the detection data may be used to determine a signal pattern suitable for each vehicle at a time when the yellow signal is emitted.

According to an embodiment, the control server 300 may analyze the timing of the yellow signal shift of the main traffic light and the speed and location data of the vehicle received from the detection device 100 in real time to calculate whether each of a plurality of vehicles is able to enter the intersection. The control server 300 generates lighting control signals for a plurality of LED modules based on the data, allowing real-time adjustment of an intersection entry-allowable section and a stop section in real time.

In the embodiment, the yellow signal of the intersection indicates an intermediate state in which the traffic light changes from green to red and may be a point in time that is the main cause of a dilemma zone in which a vehicle needs to determine whether to pass through the intersection or stop. The yellow signal is generally maintained for a certain duration, and at this point, determining whether a vehicle is able to enter the intersection based on the location and speed of the vehicle is important for traffic safety and smooth flow.

In addition, the control server 300 generates lighting control signals for controlling the lighting of each of the plurality of LED modules in real time according to the change in the location of each vehicle, and dynamically adjusts an intersection entry-allowable section and a stop section to provide an individual visual signal according to the direction in which the vehicle is headed.

Specifically, the control server 300 may compare the time required to enter the intersection and the current signal status based on the speed and location data of each vehicle to calculate whether the vehicle is able to safely pass through the intersection (i.e., whether the vehicle is able to enter the intersection). For example, when a vehicle is able to completely pass through an intersection before the yellow signal ends, an LED module in a section in which the vehicle is located emits a green signal. Conversely, when the vehicle is not able to pass through the intersection, the LED module in the section in which the vehicle is located emits a red signal to provide a stop signal.

For a more specific example, since a vehicle close to an intersection is more likely to safely pass through the intersection even when moving at a relatively high speed, the control server 300 lights the LED module in the section in which the vehicle is located in green. On the other hand, a vehicle that is far from the intersection and moving at a low speed is more likely to encounter the yellow signal ending before reaching the intersection, and thus the control server 300 lights the LED module in the section in which the vehicle is located in red to provide a stop signal.

That is, the control server 300 comprehensively considers data, such as the direction, speed, and location of the vehicle, and provides individual lighting signals for the LED modules in the section in which each vehicle is located. Such individual signals are effective in preventing conflicting decisions between vehicles and reducing the risk of accidents at the intersection. In particular, the control server 300 continuously updates the lighting status of the LED module according to the change in the location of each vehicle, thereby providing an appropriate signal as the vehicle moves.

In addition, the control server 300 may urgently change the lighting pattern in a specific situation. For example, when the intervals between vehicles suddenly narrow, the control server 300 sets the stop section wider and reduces the intersection entry-allowable section, thereby reducing the possibility of an accident. Such real-time control contributes to improving both the safety of traffic flow and efficiency.

According to an embodiment, the installation location of the detection device 100 may be adjusted according to the characteristics of the intersection and the length of the road connected to the intersection. In general, the detection device 100 is installed at a certain interval from a starting point of a road in each direction connected to the intersection and is configured to collect continuous movement data of the vehicle in real time.

For example, as illustrated in FIG. 1, the detection device 100 may be disposed in the entry direction of each road connected to the intersection, and may detect the speed, location, and direction data of the vehicle approaching the intersection in real time. The detection device 100 may have a plurality of sensor modules arranged in a series starting from a location a certain distance away from the intersection to a section close to the intersection to precisely track the vehicle's movement trajectory. With such installation locations, the vehicle movement data is detected by section, allowing the control server 300 to provide information for determining whether each vehicle is able to enter the intersection. For example, when the detection device 100 is installed at a starting point of the road, initial speed and direction data may be collected when a vehicle passes the corresponding location, and a sensor module installed in a section close to the intersection tracks the acceleration or deceleration status of the vehicle in real time to support more sophisticated data analysis.

In an embodiment, the installation interval of the detection device 100 may be determined in consideration of the characteristics of the road connected to the intersection, the average speed of the vehicles, the congestion of the intersection, and the like. For example, in a straight section of the road, sufficient data collection is possible even when the detection devices are arranged at relatively wide intervals, but in a section close to the intersection, the detection devices may be installed at shorter intervals to precisely detect a sudden change in speed or direction of the vehicle.

In the embodiment, the detection device 100 embedded in the ground may have durability optimized for the road environment and may be configured not to be damaged by the movement of the vehicle. For example, the detection device 100 including a pressure sensor or an ultrasonic sensor may be sealed with a high-strength material and integrated with the road surface. Through this, the detection device 100 may stably operate for a long period of time without interfering with road maintenance work.

That is, the detection device 100 may be installed in an optimal location according to the characteristics of the intersection and the road environment, thereby providing the movement data of the vehicle in real time and effectively supporting the operation of the signal system for preventing the dilemma zone.

According to an embodiment of the present invention, the detection device 100 may be installed in a road section further from the intersection than the operating device 200 and may include a plurality of sensor modules.

Referring to FIG. 3, the detection device 100 may be provided to detect the speed, location, and direction data of the vehicle from a stage before the vehicle approaches the intersection. The data is required to secure sufficient time for determining whether the vehicle is able to enter the intersection before the vehicle 10a reaches the intersection. For example, when the vehicle is traveling at a high speed, detecting data at a location close to the intersection may not provide sufficient reaction time required for traffic control and signal control. Therefore, the detection device 100 is installed on a road section farther away than the operating device 200 to collect driving information of the vehicle 10a in advance and rapidly transmit the driving information to the control server 300.

The detection device 100 includes a plurality of sensor modules, and the sensor modules may be arranged at regular intervals across a plurality of sections of the road. Each sensor module continuously collects movement information of the vehicle and may accurately detect variations in speed and directional change of the vehicle. For example, the sensor module may include an optical sensor, a radar sensor, an ultrasonic sensor, or a magnetic sensor, and each sensor performs a specialized function to detect the movement of the vehicle. The sensors may be installed in a form in which the sensors are embedded in the road floor or located at the edge of the road to monitor the passage of the vehicle in real time.

In addition, in the embodiment, the installation location and interval of the detection device 100 may be adjusted according to the structural characteristics of the intersection and the traffic flow of the road. For example, when the length of the road connected to the intersection is short or the traffic volume is high, the interval of the sensor modules may be narrowed to collect more precise data. On the other hand, on a major road that is far from the intersection, the sensor intervals may be widened to efficiently collect continuous movement data of the vehicle.

In addition, the data collected by the detection device 100 is transmitted to the control server 300 in real time and used to determine whether the vehicle is able to enter the intersection. For example, when the detection device 100 detects the speed and location of the vehicle and calculates an expected arrival time, the control server 300 may set an LED module lighting section and an LED module lighting pattern of the operating device 200 in advance based on the expected arrival time. Through this, the driver may receive a clear and intuitive visual signal at the time of entering the intersection and make a rapid and safe decision.

In addition, in the embodiment, the signal system 1000 may include an operating device 200 installed on a road section connected to an intersection to emit a visual signal related to whether a vehicle is able to drive. The operating device 200 serves to intuitively convey to a vehicle approaching the intersection whether the vehicle is able to drive, and may be implemented as a plurality of LED modules embedded in the road floor.

Specifically, the operating device 200 is installed on a road section in each direction connected to the intersection and may be appropriately disposed according to a direction in which the vehicle is approaching. The operating device 200 may have a plurality of LED modules continuously arranged up to a certain distance from the stop line of the road to provide a lighting signal according to the location of a vehicle approaching the intersection. The arrangement interval of the LED modules is determined in consideration of the characteristics of the intersection and the average speed of the vehicles, and each LED module may be configured to be independently controlled.

Specifically, the operating device 200 may dynamically emit a signal according to the driving trajectory of each vehicle. For example, when a vehicle is fast and likely to pass through the intersection, the LED module emits a green signal to clearly indicate that the vehicle is able to pass through the intersection. On the other hand, when the vehicle approaching the intersection is slow and likely to stop at the stop line, the LED module emits a red signal to provide a stop signal. Such a lighting method is dynamically controlled based on data received from the control server 300.

The LED module is sealed with a durable material and is integrated with the road surface and may be protected from physical damage caused by the movement of the vehicle and environmental factors (e.g., rain, snow, and dust).

According to an embodiment of the present invention, the operating device 200 may include a light sensor module that acquires light detection data related to the ambient light conditions. In this case, each of the plurality of LED modules included in the operating device 200 may be characterized by adjusting the lighting intensity based on the light detection data acquired from the light sensor module.

More specifically, the light sensor module detects the brightness level of the surroundings of the road in real time and provides data for setting an appropriate lighting intensity for each of the plurality of LED modules included in the operating device 200. For example, the light sensor module may detect differences in light conditions between day and night, or differences in brightness in special environments, such as a tunnel entrance and a tunnel exit.

The LED module may be designed to adjust the lighting intensity based on the light detection data received from the light sensor module. When the surroundings are bright, such as during the day, the LED module may increase the lighting intensity to emit strong light such that the driver may clearly recognize the signal. On the other hand, under conditions with low visibility such as nighttime or bad weather, the lighting intensity of the LED module may be lowered to prevent excessive light reflection from the surroundings and to clearly transmit the signal.

The light sensor module may include a plurality of optical detectors and be configured to independently detect the light conditions of each road section in which the operating device 200 is installed. Such a configuration allows each LED module to operate at a lighting intensity optimized for the environment of the corresponding section, thereby increasing energy efficiency while ensuring the clarity of signal transmission.

In addition, according to an embodiment, the lighting intensity of the LED module may be adjusted by comprehensively considering not only the surrounding brightness but also the speed and location data of the vehicle. For example, when a vehicle moving at a high speed is detected, a stronger lighting intensity may be set such that a driver of the vehicle moving at a high speed may clearly recognize the signal, and a lower lighting intensity may be set in a congested area to save energy and reduce visual confusion in the surroundings.

The lighting intensity of the LED module may be adjusted in real time according to a control signal from the control server 300, and the control is performed based on the results of a comprehensive analysis of variables, such as traffic conditions, weather, and time zone. Through this, the operating device 200 according to the present invention may adjust the lighting intensity such that a driver may clearly recognize the signal even under various environmental conditions, thereby preventing accidents in the dilemma zone and increasing the efficiency of traffic flow.

In addition, in an embodiment, the operating device 200 may adjust the lighting intensity of the LED module such that a driver may clearly recognize the signal even in an environment in which visibility is extremely reduced, such as heavy rain or fog.

For example, in a heavy rain situation, light reflection from rainwater on the road surface makes it difficult to identify the signal. In this case, the light sensor module detects the lowered ambient illuminance and the light reflections due to rainwater and transmits the detection data to the control server 300. The control server 300 may increase the lighting intensity of each LED module based on the data to improve the visibility of the signal. The LED module may emit strong light to offset the reflections from the rainwater, allowing the driver to clearly identify the signal.

In addition, in a heavy fog situation, light scattering may make it difficult to transmit signals. In this case, the light sensor module detects the density of the fog, and the control server 300 may increase the lighting intensity of the LED module while adjusting the signal emission angle. For example, in a section with thick fog, the LED module is set to emit light more concentratively or only at a specific angle such that the signal is accurately transmitted to the driver's field of vision. Such adjustment may reduce driver confusion and support smooth traffic flow at intersections.

In addition, when visibility is extremely limited due to heavy rain or fog, the lighting pattern of the LED module may be set to periodically blink such that the driver may more easily recognize the signal. The lighting pattern provides increased visibility compared to the existing continuous lighting method and may draw the driver's attention.

That is, the operating device 200 according to the present invention is adjusted such that the driver may clearly recognize the signal even in extreme environmental conditions, such as heavy rain or fog, thereby preventing accidents that may occur in the dilemma zone and maximizing the safety at the intersection.

In the embodiment, the LED module is configured to display various color signals of green, yellow, and red, and may include a blind to transmit a clear signal only to a specific vehicle. The blind is designed to adjust the emission angle of the signal such that a following vehicle does not misrecognize a signal of a preceding vehicle. For example, in a section close to the intersection, the emission angle is set narrowly such that the signal is provided only to specific vehicles, and in a section far from the intersection, the emission angle is set wide such that the signal may be transmitted to a larger number of vehicles.

In a specific embodiment, each of the plurality of LED modules may be provided with a blind that adjusts the emission angle of the visual signal such that a driver of the vehicle may identify the visual signal only at a certain angle.

Referring to FIG. 3, the blind has a structure designed to control the light emission angle of the visual signal such that the following vehicle does not misunderstand the signal of the preceding vehicle. The blind is installed on an upper portion or front side of the LED module and serves to limit the directionality of the light emitted from the LED module.

In an embodiment, the angle of the blind is precisely designed considering the average field of vision of drivers of vehicles and the slope of the road. For example, the blind is designed such that the driver of the vehicle observes the LED module at an angle less than or equal to about 15° from the road surface, providing an effect of the signal disappearing when the vehicle approaches the LED module, thereby preventing signal confusion.

For example, the blind may include a plurality of thin wing-shaped structures, and the wings may be arranged at a certain angle such that light is emitted only at a certain angle. For example, the blind may be adjusted such that the signal may be clearly transmitted to a vehicle close to the intersection while the signal may not be visible to a following vehicle.

In an embodiment, the blind may be provided to prevent the diffusion of light such that the signal is not emitted to an area outside of a specified angle. For this, the blind is manufactured with a light-resistant material, and a matte finish may be applied to the surface to minimize light reflection. In addition, the blind is formed of a material that is resistant to external impact and climate change to ensure durability in a road environment and may be manufactured with a material such as metal or high-strength plastic. These structural features enable the blind to stably operate for a long time.

That is, the blind is a key element designed to be integrated into each LED module to limit the light emission angle such that the driver may clearly recognize the signal and to prevent the following vehicle from misrecognizing the signal of the preceding vehicle. Such a design and implementation of a blind supports the effective operation of the floor signal system for preventing a dilemma zone and may contribute to improving traffic safety.

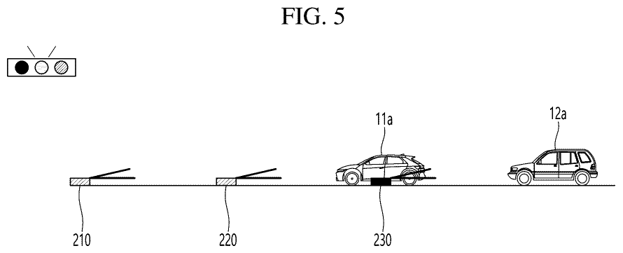

As a specific example, referring to FIG. 5, the LED modules 210, 220, and 230 provide individual signals according to the location of each vehicle, and the blind plays an important role in preventing signal confusion between vehicles. It may be assumed that a front vehicle 11a has received a pass-through signal indicating the ability to enter the intersection from the LED module 230, and a rear vehicle 12a has received a stop signal from the LED module 220.

In this case, the front vehicle 11a may observe the pass-through signal provided thereto and make a decision to continue to the intersection. On the other hand, the rear vehicle 12a receives the stop signal and needs to stop entering the intersection. In this situation, the blind controls the light emission angle of the LED module such that each vehicle may clearly recognize only its own signal. For example, when the front vehicle 11a reaches the vicinity of the LED module 230, the light emission angle of the signal may be limited by the blind such that the stop signal for the rear vehicle 12a is not visible to the front vehicle 11a.

Such a design prevents the rear vehicle 12a from making a wrong decision to enter the intersection by misunderstanding the pass-through signal provided to the front vehicle 11a. Similarly, the front vehicle 11a may make a safe driving decision based on the pass-through signal according to its own location. The function of the blind contributes to preventing signal confusion between vehicles by selectively displaying the signal of the LED module according to the location of each vehicle and the driver's viewing angle.

As a result, the LED module including the blind provides a customized signal based on the location and speed of each vehicle, thereby supporting the driver in making the right decision without confusion in the dilemma zone and effectively reducing the risk of accidents at the intersection.

According to an embodiment of the present invention, each of the plurality of LED modules is formed so that an arrangement angle of the blind gradually changes with an increasing distance from the intersection to increase the light emission angle such that the visual signal is identified at a wider angle as the distance from the intersection increases.

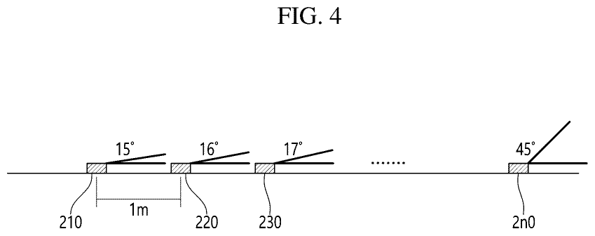

Referring to FIG. 4, the LED modules 210, 220, and 230 are arranged at regular intervals from the intersection, and the arrangement angle of the blind included in each module gradually increases according to the change in distance from the intersection.

For example, the LED module 210 close to the intersection is provided with a blind having a light emission angle set to about 15° such that the signal may be identified only when the vehicle is located near the LED module. Then, the LED modules 220 and 230, which are progressively farther from the intersection, are provided with blinds having increased light emission angles of about 16° and 17°, respectively, such that the signal may be emitted at a wider angle. The angle of the blind is set to about 45° at a point 2n0 about 30 m away from the intersection, such that the signal may be transmitted to a wider range of vehicles. Such a design allows vehicles far from the intersection to clearly recognize the signal and contributes to preventing signal confusion.

In areas close to the intersection, the light emission angle is set narrowly such that signals are transmitted only to specific vehicles, and as the distance from the intersection increases, the light emission angle becomes wider such that a larger number of vehicles may recognize the signals. Such a gradual change prevents following vehicles from misrecognizing the signal of the preceding vehicle and maximizes the efficiency of signal transmission at intersections.

In other words, LED modules near the stop line are installed with blinds having a light emission angle of about 15°, and the blind angle may be increased by 1° for each meter away from the stop line. For example, at a point about 30 meters away from the stop line, the blind angle becomes 45° and LED modules beyond this point may not be installed with blinds. This may be mainly to ensure that drivers may clearly identify the signal from all angles in the rear area in which the red signal is emitted. Such an arrangement structure has the benefit of preventing signal confusion and supporting drivers in making decisions appropriate for the driving situation.

In addition, in the embodiment, the control server 300 may generate a control signal for variably adjusting the light emission angle of the blind based on traffic congestion, time zone, or vehicle flow data. In this case, each of the plurality of LED modules may adjust the light emission angle of the blind in real time according to the control signal received from the control server 300.

The blind may be formed with a structure that allows the light emission angle to be dynamically adjusted according to the location of the vehicle and the road environment. In the embodiment, the blind is configured to mechanically or electronically adjust the angle according to the control signal received from the control server 300 such that the driver of the vehicle may clearly recognize the signal at a specific location.

Specifically, the blind may include a plurality of thin wing-shaped structures arranged on the upper portion of the LED module, and the wings may be adjusted in angle by a variable mechanism. For example, the wing-shaped blind may control the inclination by utilizing a small motor, an electronic actuator, or a smart material (e.g., a memory alloy). Such a mechanism may dynamically change the light emission angle according to the location of the vehicle and changes in the road environment by receiving a control signal from the control server 300 and adjusting the angle in real time.

For example, LED modules close to an intersection may have the light emission angle set narrow such that signals are transmitted only to nearby vehicles, while LED modules farther from the intersection may have the light emission angle set wide such that a larger number of vehicles identify the signal. In this process, the control server 300 may analyze vehicle speed, location, direction, and traffic congestion data in real time to calculate the appropriate angle of each blind and generate and transmit a control signal based on the calculated angle.

The blind adjustment mechanism is formed of durable materials and is designed to stably operate even with changes in an external environment such as vehicle vibration and weather. For example, the blind may be formed of a high-strength plastic, aluminum alloy, or elastic memory alloy, which are resistant to external impact and do not deform even after repeated angle adjustments.

According to an embodiment, the angle of the blind is adjusted in real time according to various situations such that the driver of the vehicle may clearly recognize the signal. In the case of high traffic congestion, the control server 300 adjusts the light emission angle of the blind to a limited extent considering the possibility of confusion occurring due to the narrow interval between vehicles. This ensures that the signal is clearly transmitted only to specific vehicles and prevents drivers of nearby vehicles from recognizing the wrong signal.

In addition, in situations with low visibility such as nighttime or bad weather, the control server 300 dynamically adjusts the blind angle based on light data and weather data. At night, the light emission angle is set narrowly to prevent the LED signal from being excessively diffused and allow the signal to be viewable only to nearby vehicles, and in foggy or low-visibility environments, the angle is adjusted such that the LED light spreads to a wider angle such that a large number of vehicles may see the signal.

In high-speed driving situations in which the vehicle speed is fast, the control server 300 adjusts the blind angle to widen because the signal needs to be recognized within a short time. On the other hand, in traffic jams or when the vehicle speed is slow, the light emission angle may be set narrowly to transmit the signal only to nearby vehicles, thereby preventing confusion.

Even when straight-moving vehicles and left-turning vehicles are located on the same road section at an intersection, the blind angle adjustment allows the vehicles headed in different directions to clearly recognize different signals. For example, signals are transmitted at a lower angle to the straight-moving vehicles and at a higher angle to the left-turning vehicles, allowing different signals to be distinguished in the same section.

In addition, in a section far from the intersection, the light emission angle is set wide such that a larger number of vehicles may identify the signal, and in a section close to the intersection, the light emission angle is narrowed such that nearby vehicles may clearly recognize the signal. Such an adjustment helps maintain the accuracy of signal transmission even in sections with high traffic density.

When an emergency vehicle is detected, the control server 300 adjusts the blind angle based on the route and speed data of the emergency vehicle. The blind angle of the corresponding route is widened such that the emergency vehicle may pass first, and the blind angle for other vehicles that are at risk of collision with the emergency vehicle is limited such that the stop signal is clearly transmitted to the vehicles.

Such blind angle adjustment is automatically performed by the control server 300 analyzing the vehicle's location, speed, and direction data in real time to calculate the appropriate angle of each blind and generating a control signal. This allows the driver to clearly recognize the signal in various traffic situations and reduces the possibility of traffic accidents by increasing the accuracy and efficiency of signal transmission.

According to an embodiment of the present invention, the operating device 200 may operate in response to an emergency vehicle or a specific situation. For example, when an emergency vehicle is approaching, the LED module displays an expected passage route of the emergency vehicle such that other vehicles may clearly recognize the passage route and yield the right of way.

More specifically, the detection device 100 may further include an emergency vehicle detection module that detects the approach of an emergency vehicle to an intersection and generates emergency vehicle approach data.

The emergency vehicle detection module detects the approach of an emergency vehicle in real time based on data such as the vehicle's speed, direction, horn signal, or activation of emergency lights (siren and emergency lights). The detected emergency vehicle approach data is transmitted to the control server 300, and the control server 300 analyzes the data to control the lighting status of the LED module such that the emergency vehicle passes through the intersection safely and rapidly.

The emergency vehicle may include vehicles designated to respond to public safety and emergency situations, such as fire trucks, ambulances, police cars, and disaster response vehicles. When the approach of an emergency vehicle is detected, the control server 300 may light LED modules of a road section corresponding to an expected passage route of the emergency vehicle in green or apply a specific lighting pattern (e.g., blinking) to clearly indicate the route of the emergency vehicle.

In an embodiment, the control server 300 may turn on LED modules corresponding to the expected passage route of the emergency vehicle among a plurality of LED modules based on the emergency vehicle approach data received from the emergency vehicle detection module to indicate the priority passage route of the emergency vehicle, and may provide a stop signal to other general vehicles at risk of colliding with the emergency vehicle within the intersection section.

For example, the control server 300 analyzes data received from the emergency vehicle detection module in real time to calculate the route and expected direction of movement of the emergency vehicle approaching the intersection. Based on the analysis results, LED modules of a road section corresponding to the route along which the emergency vehicle is to travel emit a green signal, and a blinking pattern may be added as needed to clearly emphasize the route of the emergency vehicle.

In addition, the control server 300 identifies other vehicles that are at risk of colliding with the emergency vehicle at the intersection, and turns on a red signal in the LED module of a road section in which the vehicles are located to provide a stop signal. For example, when the emergency vehicle is moving in a straight direction, a stop signal may be emitted for a left-turning or right-turning vehicle attempting to enter the intersection, thereby minimizing the possibility of a collision within the intersection.

In an embodiment, the control server 300 may track the location and speed of the emergency vehicle in real time by utilizing vehicle-to-vehicle (V2V) technology or vehicle-to-infrastructure (V2I) and continuously update the LED module status until the emergency vehicle completes movement. For example, after the emergency vehicle passes through the intersection, the LED modules of the corresponding road section are immediately restored to a normal signal state such that traffic of general vehicles may be resumed.

As described above, the control server 300 may rapidly and safely support the passage of the emergency vehicle, and prevent traffic confusion and maintain smooth traffic flow at the intersection by providing clear visual signals to general vehicle drivers.

According to an embodiment, the control server 300 may detect the signal status of the intersection to determine whether the yellow signal shift has occurred, and based on the timing of the yellow signal shift, control the lighting section and lighting pattern of the operating device 200 based on the detection data received from the detection device.

When the yellow signal is emitted, the control server 300 calculates in real time whether each vehicle is able to safely pass through the intersection based on the speed, location, and direction data of the vehicle received from the detection device. For example, when a vehicle is approaching the intersection and is likely to completely pass through the intersection before the yellow signal ends, the control server 300 lights LED modules of a section in which the vehicle is located in green to provide a pass-through signal. On the other hand, when the vehicle is far from the intersection or has a low speed and thus entering the intersection is not safe, the LED module emits red to clearly convey a stop signal.

In addition, the control server 300 may continuously update the lighting status of the LED module of the operating device 200 according to the change in the location of the vehicle. For example, when the vehicle is rapidly approaching the intersection, the control server 300 appropriately adjusts the signal according to the end time of the yellow signal while progressively shifting the lighting section in the direction of the intersection. In this process, the control server 300 may provide different signals to a plurality of vehicles entering the intersection, thereby preventing conflicting decisions between vehicles and minimizing the possibility of an accident.

In addition, the control server 300 synchronizes the exact switching time of the yellow signal in association with the intersection signal control system and control the lighting pattern of the LED module based on the information. For example, the control server 300 may finely adjust the lighting time of the LED module to clearly distinguish the intersection entry section and the stop section based on the start and end times of the yellow signal provided by the signal control system. This reduces the burden on drivers in driving decision at the intersection and supports smooth traffic flow.

According to various embodiments of the present invention, the signal system 1000 may further include an additional detection device for obtaining complexity data within the intersection. For example, the additional detection device may include various types of sensor modules and may calculate the complexity, for example, by calculating the average speed of vehicles within the intersection or counting the number of vehicles within a specific time interval.

In an embodiment, the additional detection device may be characterized by generating the complexity data based on data regarding the speed and number of vehicles within the intersection.

More specifically, when the additional detection device detects that the speed of a vehicle in the intersection decreases below a set reference speed or the number of vehicles exceeds a certain threshold, the additional detection device determines that the complexity in the intersection is high and generates the information as complexity data. For example, when the average vehicle speed in the intersection decreases below 20 km/h or the number of vehicles in the intersection exceeds 10, the complexity data may be displayed as “high.”

The additional detection device transmits the data to the control server 300 in real time, and the control server 300 analyzes the complexity data preferentially to readjust whether the vehicle is able to enter the intersection. For example, when it is initially determined that a specific vehicle is able to enter the intersection, but the complexity data received from the additional detection device indicates high congestion, the control server 300 may reflect the complexity data and provide an intersection entry prohibiting signal to the vehicle.

In the embodiment, the additional detection device may be installed in conjunction with the main traffic light, thereby more effectively collecting situation data in the intersection. It is also possible to detect a vehicle flow and speed information of vehicles in the intersection using a camera module or radar sensor installed in the main traffic light. Such a configuration may enable more intelligent signal control depending on the intersection situation.

According to an embodiment, the control server 300 may determine whether the intersection entry is possible by reflecting the complexity data with priority over the detection data received from the detection device 100 and control the operating device 200 based on the determination result.

In more detail, the control server 300 uses the speed, location, and direction data of the vehicle received from the detection device 100 as initial input values to primarily determine whether the vehicle is able to enter the intersection. However, the real-time traffic situation within the intersection may have unexpected variability, and such variability may reduce the accuracy of the initial determination. For example, even when a vehicle is determined as being able to enter the intersection in the initial determination, in the event of congestion within the intersection or the traffic flow disruption, the entry of the vehicle may actually increase the possibility of a collision within the intersection or impede the traffic flow.

To prevent this, the control server 300 analyzes complexity data, such as the average speed of vehicles in the intersection, the number of vehicles, and whether there is congestion in real time from the additional detection device, and upon determining that the congestion in the intersection is high, the control server 300 readjusts the initial decision result. When the speed of vehicles in the intersection decreases below a reference speed or the number of vehicles exceeds a threshold and the intersection reaches a congested state, the control server 300 modifies a determination regarding whether the vehicle is able to enter based on the data from the additional detection device to maintain safe intersection operation.

For example, when vehicle entry is allowed in a state in which the congestion in the intersection is high, the possibility of collision with the existing vehicles in the intersection may increase, or additional congestion may occur, which may have a negative impact on the overall traffic flow. To prevent this, the control server 300 evaluates the situation in the intersection in real time by preferentially reflecting the complexity data, and when needed, controls the operating device 200 to display a stop signal or provide a deceleration signal even to vehicles that are able to enter the intersection.

Conversely, when the complexity data indicates a low level of congestion in the intersection, for example, when the average speed of vehicles is higher than the reference speed and the number of vehicles is lower than the threshold, the control server 300 maintains the initial determination or controls a pass-through signal to be displayed, thereby supporting efficient vehicle flow.

Such a mechanism takes into account the fact that the congestion in the intersection may reduce the reliability of the initial determination result, and the control server 300 may reflect the complexity data, thereby immediately responding to changes in traffic conditions and minimizing the risk of collision and congestion in the intersection. As a result, the safety and efficiency of the intersection may be significantly improved.

As is apparent from the above, according to various embodiments of the present invention, the flow signal system can analyze the speed and location of a vehicle approaching an intersection and traffic conditions in real time and provide a clear visual signal that allows a driver to intuitively determine whether to drive. In other words, the flow signal system can reduce the risk of collision between vehicles and contribute to preventing traffic accidents in the intersection by preventing a dilemma zone at a yellow signal shift.

In addition, the flow signal system can prevent signal misrecognition and significantly improve the safety at the intersection through arrangement of signals with consideration of a driver's blind spot.

The effects of the present invention are not limited to those described above, and other effects that are not described above will be clearly understood by those skilled in the art from the above detailed description.

Although embodiments of the present disclosure have been described above with reference to the accompanying drawings, those of ordinary skill in the art to which the present disclosure pertains can realize that the present disclosure can be embodied in other specific forms without changing its technical spirit or essential features. Therefore, it should be understood that the embodiments described above are illustrative in all respects and not restrictive.

The specific implementations described in the present disclosure are examples, and do not limit the scope of the present disclosure in any way. For brevity of the specification, description of conventional electronic components, control systems, software, and other functional aspects of the systems may be omitted. In addition, the connections or connecting members of the lines between the components shown in the drawings exemplify functional connections and/or physical or circuit connections, and in an actual device, various functional connections or physical connections that can be replaced or added may be referred to as connections, or circuit connections. In addition, unless there is a specific reference such as describing something as “essential” or “important,” it may not be a necessary component for the application of the present invention.

It is understood that the specific order or hierarchy of steps in the presented processes is an example of exemplary approaches. Based on design priorities, it is to be understood that the specific order or hierarchy of steps in the processes may be rearranged within the scope of the present disclosure. The appended method claims present elements of the various steps in a sample order, which are not meant to be limited to the specific order or hierarchy presented.

The description of the presented embodiments is provided to enable any person skilled in the art to make or use the present disclosure. Various modifications to these embodiments will be readily apparent to those skilled in the art, and the generic principles defined herein may be applied to other embodiments without departing from the scope of the present disclosure. Thus, the present disclosure is not intended to be limited to the embodiments presented herein but is to be construed in the widest scope consistent with the principles and novel features presented herein.

What is claimed is:

1. A floor signal system for preventing a dilemma zone, which is a system for detecting a speed and a location of a vehicle at an intersection section and preventing a driver's dilemma zone, the system comprising:
a detection device that detects a speed, a location, and a direction of a vehicle approaching an intersection and generates detection data;
an operating device installed in a road section connected to the intersection and emitting a visual signal related to whether to allow a vehicle to enter the intersection; and
a control server that detects a signal status of the intersection and determines whether a yellow signal shift occurs, and based on a timing of the yellow signal shift, controls a lighting section and a lighting pattern of the operating device based on the detection data received from the detection device.

2. The floor signal system of claim 1, wherein the detection device is installed on a road section farther from the intersection than the operating device and is provided with a plurality of sensor modules, and
the operating device includes a plurality of light emitting diode (LED) modules arranged at a certain interval on the road section connected to the intersection, and
each of the plurality of LED modules is provided with a blind that adjusts a light emission angle of the visual signal such that a driver of the vehicle identifies the visual signal only at a specific angle.

3. The floor signal system of claim 2, wherein each of the plurality of LED modules is formed so that an angle of the blind gradually changes with an increasing distance from the intersection to increase the light emission angle such that the visual signal is identified at a wider angle as the distance from the intersection increases.

4. The floor signal system of claim 2, wherein the control server generates a control signal for variably adjusting the light emission angle of the blind based on traffic congestion, time zone, or vehicle flow data, and
each of the plurality of LED modules adjusts the light emission angle of the blind in real time according to the control signal received from the control server.

5. The floor signal system of claim 2, wherein the operating device includes a light sensor module that obtains light detection data related to ambient lighting conditions, and
the plurality of LED modules adjust a lighting intensity based on the light detection data obtained from the light sensor module.

6. The floor signal system of claim 1, wherein the control server analyzes in real time the timing of the yellow signal shift and the data regarding the speed and location of the vehicle received from the detection device to calculate whether to allow each of a plurality of vehicles to enter the intersection, and
generates in real time a lighting control signal for controlling the lighting of each of the plurality of LED modules according to a change in a location of each vehicle and dynamically adjusts an intersection entry-allowable section and a stop section to provide an individual visual signal according to a direction in which the vehicle is headed.

7. The floor signal system of claim 6, further comprising an additional detection device that obtains complexity data within the intersection,
wherein the additional detection device generates the complexity data based on data on a speed and number of vehicles in the intersection, and
the control server determines whether to allow a vehicle to enter the intersection by reflecting the complexity data with priority over the detection data received from the detection device, and controls the operating device based on a result of the determination.

8. The floor signal system of claim 1, wherein the detection device further includes an emergency vehicle detection module that detects an approach of an emergency vehicle to the intersection and generates emergency vehicle approach data, and
the control server, based on the emergency vehicle approach data received from the emergency vehicle detection module, turns on LED modules corresponding to an expected passage route of the emergency vehicle among the plurality of LED modules to indicate a priority passage route of the emergency vehicle, and provides a stop signal to other general vehicles that have a possibility of colliding with the emergency vehicle within the intersection section.
